(19) United States
(12) Patent Application Publication
(10) Pub. No.: US 2007/0003338 A1
(43) Pub. Date: Jan. 4, 2007

(54) Image forming apparatus and toner collection method to be used for the same

(75) Inventor: Sunao Takenaka, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/452,045

(22) Filed: Jun. 13, 2006

(30) Foreign Application Priority Data
Jun. 30, 2005 (JP) 2005-192603

(51) Int. Cl. G03G 21/00; G03G 21/12

(52) U.S. Cl. 399/350; 399/358; 399/360

(57) ABSTRACT

A technique can prevent problems from arising due to the toner scraped off from the surface to be cleaned and improve the serviceability of a cleaning device in an image forming apparatus comprising the cleaning device whose cleaning blade can be brought into contact with and moved away from the surface to be cleaned. An image forming apparatus comprises a cleaning blade 101 that can be brought into contact with and moved away from the surface to be cleaned moving in a predetermined direction and scrapes off the toner adhering to the surface to be cleaned when held in contact with the surface, a toner collecting container 102 that collects the toner scraped off from the surface to be cleaned by the cleaning blade 101 and a toner receiving member 103 that is arranged below the toner collecting container 102 as a member separate and independent from the toner collecting container 102 so as to receive the toner falling down from the vicinity of the toner collecting container 102.

### BACKGROUND OF THE INVENTION

1. Field of the Invention

This invention relates to an image forming apparatus and a toner collection method to be used for such an image forming apparatus.

2. Description of the Related Art

Cleaning devices adapted to scrape off and collect the unnecessary toner adhering to the photosensitive surface of the photosensitive material and the transfer surface of the intermediate transfer body in image forming apparatus by means of a cleaning blade that can be brought into contact and moved away from the photosensitive surface and the transfer surface are known.

FIG. 3 of the accompanying drawings schematically illustrates the configuration of the cleaning device and its vicinity of a known image apparatus. As shown in FIG. 3, the cleaning device 9 of the known image forming apparatus takes a role of removing the unnecessary toner adhering to the transfer surface of the intermediate transfer belt 3.

The cleaning device 9 can turn around the rotary shaft R′ so that a cleaning blade 901 is brought into contact and moved away from the transfer surface as the cleaning device 9 turns. The unnecessary toner adhering to the transfer surface of the intermediate transfer belt 3 is scraped off by the cleaning blade 901 when the blade contacts the transfer surface and collected in a toner collecting container 902.

As shown in FIG. 3, since the angle of inclination of the cleaning blade 901 is small relative to a horizontal plane in the cleaning device 9 of the known image forming apparatus, the toner scraped off from the transfer surface to be cleaned can gradually be accumulated on a lateral surface of the cleaning blade 901 to produce a toner pool D on the cleaning blade 901. The toner of the toner pool D can, if partly, re-adhere to the cleaned surface.

Additionally, since the entire cleaning device 9 is turned with the cleaning blade 901 of the known image forming apparatus, the toner accumulated in the toner pool D can, if partly, fall down as the cleaning device 9 vibrates and/or does other motions when it is turned. An arrangement of providing the cleaning device 9 with a toner receiving member for receiving the falling toner as integral part thereof and disposing it below the toner collecting container 902 is also known. However, with such an arrangement, when the cleaning device 9 is turned, the toner receiving member is also turned to give rise to a problem of complex structure and a low controllability of the rotary angle of the turning cleaning device 9.

Still additionally, with the arrangement of providing the cleaning device with a toner receiving member as integral part thereof, the toner receiving member needs to be moved with the cleaning device when the latter is to be serviced. Then, the toner accumulated in the toner receiving member can, if partly, fall into the cleaning device to make the servicing operation difficult.

### SUMMARY OF THE INVENTION

In view of the above-identified problems of the prior art, it is therefore the object of the present invention to provide a technique of preventing problems from arising due to the toner scraped off from the surface to be cleaned and improving the serviceability of a cleaning device in an image forming apparatus comprising the cleaning device whose cleaning blade can be brought into contact with and moved away from the surface to be cleaned.

In an aspect of the present invention, the above object is achieved by providing an image forming apparatus comprising: a cleaning blade that can be brought into contact with and moved away from the surface to be cleaned moving in a predetermined direction and scrapes off the toner adhering to the surface to be cleaned when held in contact with the surface; a toner collecting container that collects the toner scraped off from the surface to be cleaned by the cleaning blade; and a toner receiving member that is arranged below the toner collecting container as a member separate and independent from the toner collecting container so as to receive the toner falling down from the vicinity of the toner collecting container.

In another aspect of the present invention, there is provided an image forming apparatus comprising: a cleaning means that can be brought into contact with and moved away from the surface to be cleaned moving in a predetermined direction and scrapes off the toner adhering to the surface to be cleaned when held in contact with the surface; a toner collection means for collecting the toner scraped off from the surface to be cleaned by the cleaning means; and a toner reception means that is arranged below the toner collection means as a section separate and independent from the toner collection means so as to receive the toner falling down from the vicinity of the toner collection means.

In still another aspect of the present invention, there is provided a toner collection method to be used for an image forming apparatus, the method comprising: a cleaning a surface to be cleaned by bringing a cleaning blade into contact with and moving it away from the surface to be cleaned moving in a predetermined direction and by causing it to scrape off the toner adhering to the surface to be cleaned when held in contact with the surface; a collecting the toner scraped off from the surface to be cleaned by a toner collecting container; and a receiving the toner falling down from the vicinity of the toner collecting container by the toner receiving member arranged below the toner collecting container as a member separate and independent from the toner collecting container.

Thus, as described above in detail, according to the present invention, it is possible to provide a technique of preventing problems from arising due to the toner scraped off from the surface to be cleaned and improving the serviceability of a cleaning device in an image forming apparatus comprising the cleaning device whose cleaning blade can be brought into contact with and moved away from the surface to be cleaned.

### BRIEF DESCRIPTION OF THE DRAWINGS

FIG. 1 is a schematic illustration of the cleaning device and its vicinity of an embodiment of image forming apparatus according to the invention;

FIG. 2 is a table illustrating the relationship between the angle of inclination θ of the cleaning blade relative to a horizontal plane and the amount of toner accumulated on a lateral surface of the cleaning bladed to form a toner pool; and

FIG. 3 is a schematic illustration of the cleaning device and its vicinity of a known image forming apparatus.

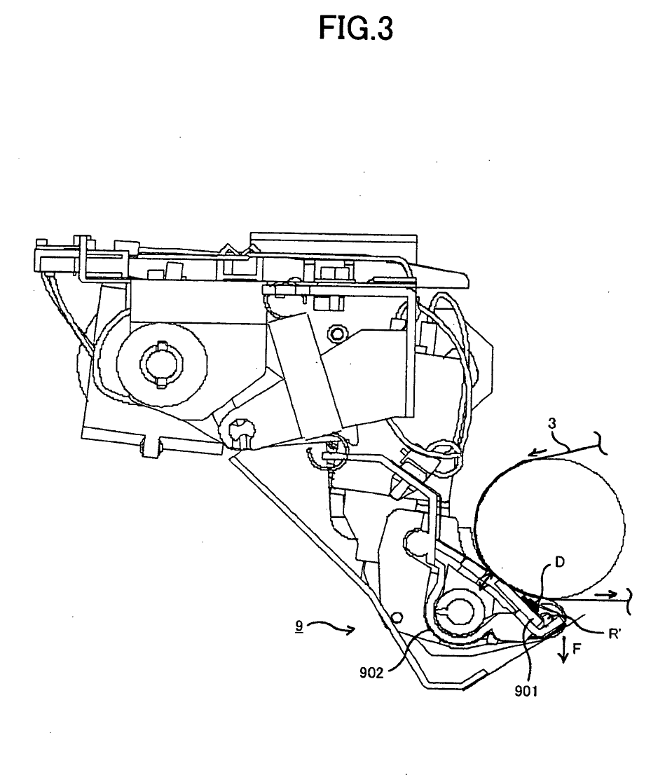

### DETAILED DESCRIPTION OF THE PREFERRED EMBODIMENT

Now, the present invention will be described by referring to the accompanying drawings that illustrate a preferred embodiment of the invention.

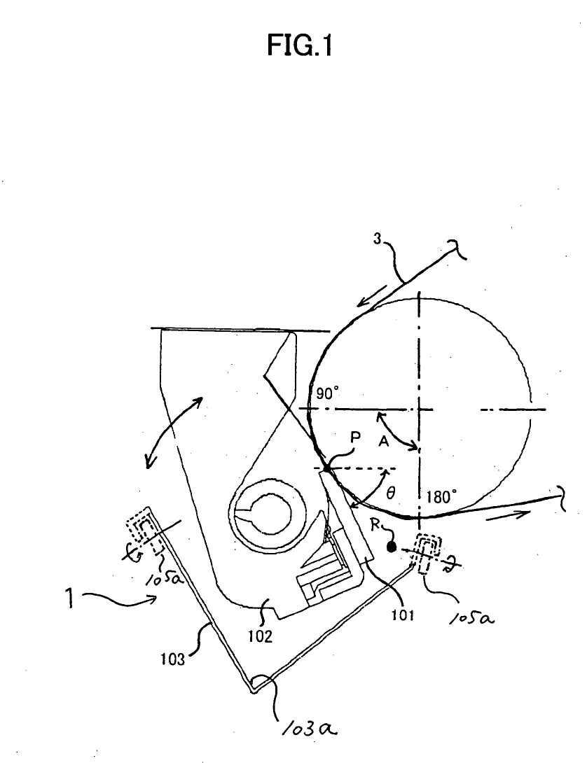

FIG. 1 is a schematic illustration of the cleaning device and its vicinity of an embodiment of image forming apparatus according to the invention. This embodiment of image forming apparatus typically comprises an MFP (multi-function peripheral) and other components.

The cleaning device 1 of this embodiment of image forming apparatus is arranged near the intermediate transfer belt 3 for transferring a toner image on a sheet and includes a cleaning blade 101, a toner collecting container 102 and a toner receiving member 103.

The cleaning blade 101 can be brought into contact with and moved away from the transfer surface (the surface to be cleaned) of the intermediate transfer belt that is driven to move in a predetermined direction (in the direction of the arrow in FIG. 1) and takes a role of scraping off the toner adhering to the transfer surface when it is held in contact with the transfer surface.

While the surface to be cleaned is a surface of the intermediate transfer belt in this embodiment, the present invention is by no means limited thereto and may alternatively be a surface of an intermediate transfer roller (the transfer surface of an intermediate transfer body) or the photosensitive surface of a photosensitive material.

The toner collecting container 102 takes a role of collecting the toner scraped off from the transfer surface by the cleaning blade 101.

The toner receiving member 103 is arranged below the toner collecting container 102 and separate and independent from the toner collecting container 102. It takes a role of receiving the toner falling from the vicinity of the toner collecting container 102.

The toner receiving member 103 has a containing section 103a for receiving the toner falling from the vicinity of the toner collecting container 102 and collecting toner at the side remote from the surface to be cleaned relative to the toner collecting container 102.

The cleaning blade 101 and the toner collecting container 102 are formed integrally in the cleaning device 1 and can be turned around a rotary shaft R. As they are turned around the rotary shaft R, the cleaning blade 101 is brought into contact with and moved away from the surface to be cleaned.

In this way, in the cleaning device of this embodiment of image forming apparatus, the toner receiving member 103 is arranged at a position that makes it separate and independent from the toner collecting container 102 so that the weight of the toner receiving member 103 does not adversely affect the turning motion of the cleaning blade 101 and that of the toner collecting container 102. Additionally, as the toner receiving member 103 is separate and independent from the toner collecting container 102, the degree of freedom of arrangement thereof is raised to facilitate the efforts for downsizing the device and those for achieving a space-saving effect of the device. It may be needless to say that the above-described arrangement works good for improving the controllability of the turning motion of the cleaning blade 101 and that of the toner collecting container 102.

From the viewpoint of servicing, it is possible to take out and service only the toner collecting container 102 without moving the toner receiving member 103 and/or causing the toner accumulating in the toner receiving member 103 to fall because the toner receiving member 103 is separate and independent from the toner collecting container 102.

Furthermore, it is possible to service the toner receiving member 103 after taking it out from the image forming apparatus when it is so arranged that the toner receiving member 103 becomes removably supported as it is driven to slide on a guide rail 105a from the side of the toner collecting container 102 or the main body cabinet of the image forming apparatus as indicated by a broken line in FIG. 1. Then, the toner receiving member 103 can be serviced easier. As a technique for removably supporting the toner receiving member 103, an engaging section (not shown) may be provided in addition to the guide rail in order to make the toner receiving member 103 releasably engaged. More specifically, an engaging projection may be arranged on the toner receiving member 103 while an engaging hole may be arranged at the toner collecting container 102 to make the toner receiving member 103 releasably engaged with the collecting container 102.

The cleaning position P of the cleaning blade 101 on the transfer surface, that is the surface to be cleaned, is located in the region of the transfer surface that faces downward (in the range A between 90° and 180° in FIG. 1) and the cleaning blade 101 touches the transfer surface with an angle of inclination θ between 55° and 90° relative to a horizontal plane.

Thus, as the cleaning blade 101 is made to show a steep gradient relative to a horizontal plan, it is possible to suppress the accumulation of scraped toner on a lateral surface of the cleaning blade 101.

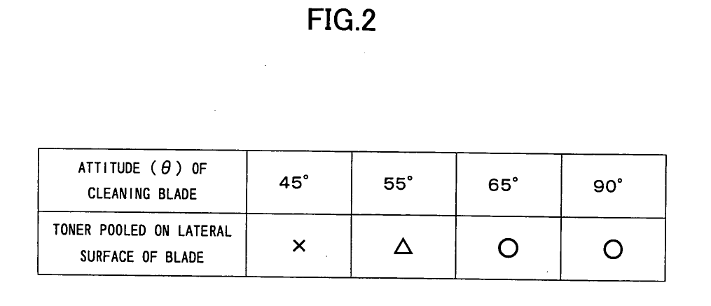

FIG. 2 shows the relationship between the angle of inclination θ of the cleaning blade relative to a horizontal plane and the amount of toner accumulated on a lateral surface of the cleaning blade to form a toner pool. It will be seen from FIG. 2 that the surface to be cleaned can be cleaned well without forming a large toner pool when the angle of inclination θ of the cleaning blade relative to a horizontal plane is found within a range between 55° and 90°.

The cleaning blade 101, the toner collecting container 102 and the toner receiving member 103 of the above-described embodiments correspond respectively to the cleaning section, the toner collection section and the toner reception section of an image forming apparatus according to the present invention.

While the present invention is described above in detail by way of a specific embodiment, the present invention is by no means limited thereto and it may be apparent to those skilled in the art that the above-described embodiment can be altered and/or modified in various different ways without departing from the spirit and scope of the present invention.

What is claimed is:

1. An image forming apparatus comprising:
a cleaning blade that can be brought into contact with and moved away from the surface to be cleaned moving in a predetermined direction and scrapes off the toner adhering to the surface to be cleaned when held in contact with the surface;
a toner collecting container that collects the toner scraped off from the surface to be cleaned by the cleaning blade; and
a toner receiving member that is arranged below the toner collecting container as a member separate and independent from the toner collecting container so as to receive the toner falling down from the vicinity of the toner collecting container.

2. The apparatus according to claim 1, wherein
the surface to be cleaned is the transfer surface of the intermediate transfer body of the apparatus.

3. The apparatus according to claim 1, wherein
the surface to be cleaned is the photosensitive surface of the photosensitive material of the apparatus.

4. The apparatus according to claim 2, wherein
the cleaning position of the cleaning blade on the surface to be cleaned is located in a region facing downward of the surface to be cleaned; and
the cleaning blade is brought into contact with the surface to be cleaned with an angle of inclination between 55° and 90° relative to a horizontal plane.

5. The apparatus according to claim 1, wherein
the toner collecting container is adapted to move integrally with the cleaning blade.

6. The image forming apparatus according to claim 1, wherein
the toner receiving member is removably provided relative to the image forming apparatus.

7. The image forming apparatus according to claim 1, wherein
the toner receiving member is adapted to receive the toner falling from the vicinity of the toner collecting container and equipped with a containing section arranged at the remote side relative to the surface to be cleaned.

8. An image forming apparatus comprising:
cleaning means that can be brought into contact with and moved away from the surface to be cleaned moving in a predetermined direction and scrapes off the toner adhering to the surface to be cleaned when held in contact with the surface;
toner collection means for collecting the toner scraped off from the surface to be cleaned by the cleaning means; and
toner reception means that is arranged below the toner collection means as a section separate and independent from the toner collection means so as to receive the toner falling down from the vicinity of the toner collection means.

9. The apparatus according to claim 8, wherein
the surface to be cleaned is the transfer surface of the intermediate transfer body of the apparatus.

10. The apparatus according to claim 8, wherein
the surface to be cleaned is the photosensitive surface of the photosensitive material of the apparatus.

11. The apparatus according to claim 9, wherein
the cleaning position of the cleaning means on the surface to be cleaned is located in a region facing downward of the surface to be cleaned; and
the cleaning means is brought into contact with the surface to be cleaned with an angle of inclination between 55° and 90° relative to a horizontal plane.

12. The apparatus according to claim 8, wherein
the toner collecting means is adapted to move integrally with the cleaning means.

13. The image forming apparatus according to claim 8, wherein
the toner receiving means is removably provided relative to the image forming apparatus.

14. The image forming apparatus according to claim 8, wherein
the toner receiving means is adapted to receive the toner falling from the vicinity of the toner collecting means and equipped with a containing section arranged at the remote side relative to the surface to be cleaned.

15. A toner collection method to be used for an image forming apparatus, the method comprising:
cleaning a surface to be cleaned by bringing a cleaning blade into contact with and moving it away from the surface to be cleaned moving in a predetermined direction and by causing it to scrape off the toner adhering to the surface to be cleaned when held in contact with the surface;
collecting the toner scraped off from the surface to be cleaned by a toner collecting container; and
receiving the toner falling down from the vicinity of the toner collecting container by the toner receiving member arranged below the toner collecting container as a member separate and independent from the toner collecting container.

16. The method according to claim 15, wherein
the surface to be cleaned is the transfer surface of the intermediate transfer body or the photosensitive surface of the photosensitive material of the image forming apparatus.

17. The method according to claim 16, wherein
the cleaning position of the cleaning blade on the surface to be cleaned is located in a region facing downward of the surface to be cleaned; and
the cleaning blade is brought into contact with the surface to be cleaned with an angle of inclination between 55° and 90° relative to a horizontal plane.

18. The method according to claim 15, wherein
the toner collecting container is adapted to move integrally with the cleaning blade.

19. The method according to claim 15, wherein
the toner receiving member is removably provided relative to the image forming apparatus.

20. The method according to claim 15, wherein
the toner receiving member is adapted to receive the toner falling from the vicinity of the toner collecting container and equipped with a containing section arranged at the remote side relative to the surface to be cleansed so as to contain toner at the side remote from the surface to be cleaned.
